(19) United States
(12) Patent Application Publication
(10) Pub. No.: US 2012/0066899 A1
(43) Pub. Date: Mar. 22, 2012

(54) QFN PROCESS FOR STRIP TEST

(75) Inventors: Saravuth Sirinorakul, Bangkok (TH); Somchai Nondhasitthichai, Bangkok (TH)

(73) Assignee: UTAC THAI LIMITED, Bangkok (TH)

(21) Appl. No.: 13/304,590

(22) Filed: Nov. 25, 2011

Related U.S. Application Data
(62) Division of application No. 12/290,188, filed on Oct. 27, 2008.
(60) Provisional application No. 61/001,961, filed on Nov. 5, 2007.

(51) Int. Cl. B23P 21/00

(52) U.S. Cl. 29/705

(57) ABSTRACT

A process for assembling semiconductor devices comprises encapsulating a leadframe matrix having semiconductor die mounted thereon in a mold compound. The leadframe matrix is partially singulated to electrically isolate each individual leadframe unit. A plurality of leadframe units is tested simultaneously. The leadframe matrix is completely singulated. Non compliant units are discarded.

### RELATED APPLICATIONS

This application claims benefit of priority under 35 U.S.C. section 119(e) of co-pending U.S. Provisional Patent Application 61/001,961 filed Nov. 6, 2007, entitled QFN PROCESS FOR STRIP TEST which is incorporated herein by reference.

### FIELD OF THE INVENTION

The present invention is in the field of semiconductor assembly and is more specifically directed methods of testing semiconductor devices during assembly.

### BACKGROUND

Semiconductor devices are generally sold in vast quantities at very small individual prices. These devices are sourced by any number of manufacturers such as National Semiconductor, On Semiconductor, ST Microelectronics and Maxim Integrated Products. These companies and many others are in fierce competition. A common cellular phone, GPS or portable music player has over a dozen semiconductor devices that have an individual cost of pennies. As a result, tiny fluctuations in manufacturing costs that result in a fraction of a penny increase are able to cause one competitor to be outbid on an order for a billion units. To that end, competitors in the semiconductor industry constantly work to reduce manufacturing costs, as a seemingly insignificant gains are the difference between success and failure.

One area of particular interest is semiconductor device testing. Each device must be validated as operational or meeting a predetermined specification before being sent to a customer. Since these units are shipped in quantities ranging from hundreds of thousands to billions, testing throughput is critical to the cost of testing. FIG. 1 shows an existing process 100 for assembling semiconductor devices. In a first step 105, a leadframe matrix 106 is attached to a tape carrier 107. In a next step 110, semiconductor die 112 are mounted to individual leadframe units. Wirebonds 113 are attached to allow electrical communication between the semiconductor die 112 and leadframe 106. In a step 115, the leadframe 106 is placed between a top mold 116 and a bottom mold 117 for encapsulation. In a step 120, the leadframe is encapsulated in a mold compound 121. In a step 125, the leadframe matrix 106 is attached to a saw tape 127 and saw blades 126 singulate the matrix. In a step 130, individual devices 133 are ready for testing. However, this serial, singular testing adds significant time, and thereby cost, to the devices.

### SUMMARY OF THE DISCLOSURE

One aspect of the disclosure is a process of assembling semiconductor devices. A leadframe matrix having semiconductor devices mounted thereon is provided and partially sawn, thereby forming partially singulated semiconductor devices. The plurality partially singulated semiconductor devices are contacted and at least one test signal is transmitted to the plurality of partially singulated semiconductor devices. At least one response signal is received from the partially singulated semiconductor devices. Any non compliant partially singulated semiconductor devices are identified and then the partially singulated semiconductor devices are completely singulated, thereby forming completely singulated semiconductor devices. Then, any non compliant partially singulated semiconductor devices are discarded. In some embodiments, providing a leadframe matrix having semiconductor devices mounted thereon further comprises providing a leadframe matrix having a plurality of individual leadframe units, mounting at least one semiconductor device in at least one of the leadframe unit, and encapsulating the leadframe matrix in a mold compound. Encapsulating the leadframe matrix in a mold compound comprises placing the leadframe matrix between a top mold and a bottom mold and injecting mold compound in a liquid state such that it encapsulates the leadframe matrix. Preferably, test signal and response signal comprise any among a DC voltage, an AC voltage, and a frequency. Preferably, identifying non compliant partially singulated semiconductor devices comprises comparing the at least one response signal to a predetermined expected response. Alternatively, identifying non compliant partially singulated semiconductor devices further comprises marking a non compliant partially singulated semiconductor device in a database.

Another aspect of the invention is a system for assembling semiconductor devices. A means for providing a leadframe matrix having semiconductor devices mounted thereon passes the matrix to a saw apparatus for partially sawing the leadframe matrix thereby forming partially singulated semiconductor devices. A contactor contacts a plurality partially singulated semiconductor devices. A means for transmitting at least one test signal to the plurality of partially singulated semiconductor devices is coupled to the contactor. The system further comprises means for receiving at least one response signal from the partially singulated semiconductor devices and means for identifying any non compliant partially singulated semiconductor devices. Also, means for completely singulating the partially singulated semiconductor devices forms completely singulated semiconductor devices and means for discarding any partially singulated semiconductor devices that did not respond according to a predetermined requirement leaves only compliant units to be shipped to a customer. The means for providing a leadframe matrix having semiconductor devices mounted thereon also has means for providing a leadframe matrix having a plurality of individual leadframe units and means for mounting at least one semiconductor device in at least one of the leadframe unit. The means for encapsulating the leadframe matrix in a mold compound also comprises means for placing the leadframe matrix between a top mold and a bottom mold and injecting mold compound in a liquid state such that it encapsulates the leadframe matrix.

### BRIEF DESCRIPTION OF THE DRAWINGS

The novel features of the invention are set forth in the appended claims. However, for purpose of explanation, several embodiments of the invention are set forth in the following figures.

FIG. 1 shows a standard method of assembling semiconductor devices.

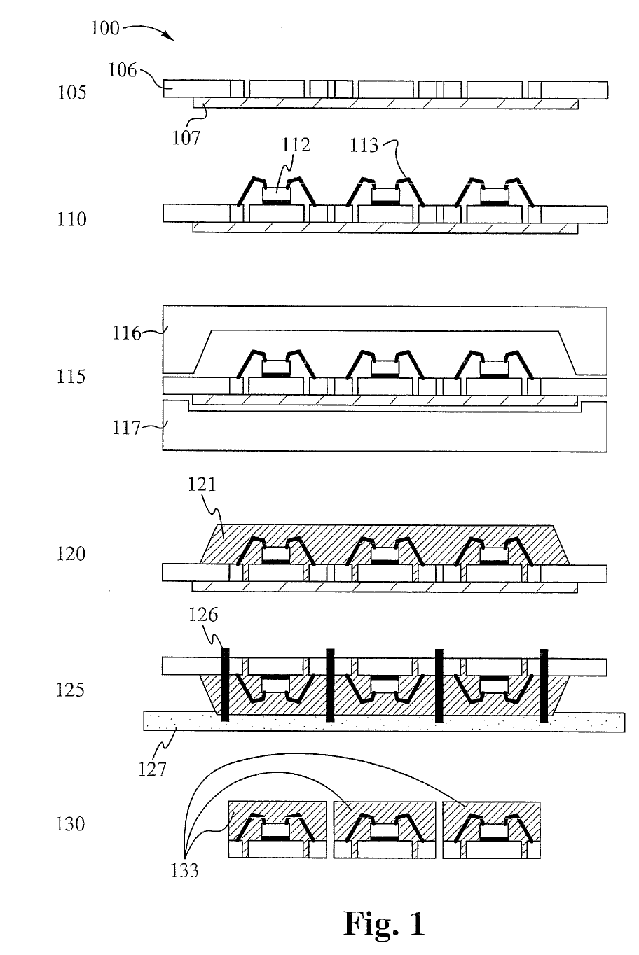

FIG. 2A shows a process for assembling and testing singulated semiconductor devices.

FIG. 2B shows the remainder of the process of FIG. 2A.

FIG. 3A shows an alternative method to the method of FIG. 2B.

FIG. 3B shows an alternative method to the method of FIG. 2B.

### DETAILED DESCRIPTION

In the following description, numerous details and alternatives are set forth for purpose of explanation. However, one of ordinary skill in the art will realize that the invention can be practiced without the use of these specific details. In other instances, well-known structures and devices are shown in block diagram form in order not to obscure the description of the invention with unnecessary detail. For example, it is commonly known in the art of semiconductor device assembly that assembly is generally done on a matrix array of leadframes, often referred to as leadframe strips, each strip having a plurality of individual positions that will be processed in various ways to form individual packaged semiconductor devices. A position can have one or more semiconductor die within. The following description details exemplary embodiments of processes. It will be appreciated by the person of ordinary skill having the benefit of this disclosure that the steps taught or claimed need not be performed in the order shown. The process steps are able to be performed in an order that is not inconsistent with the teachings herein to achieve a desired end result.

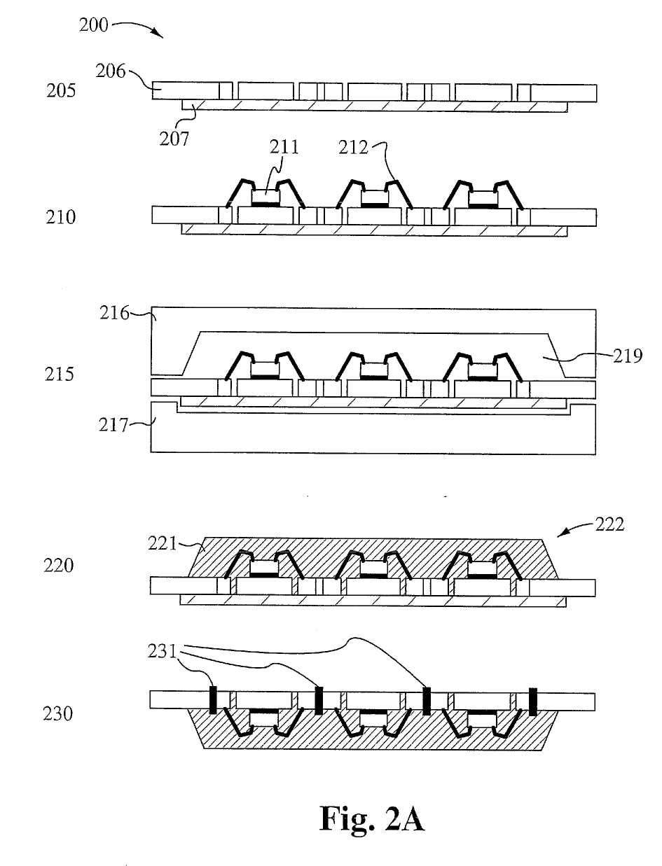

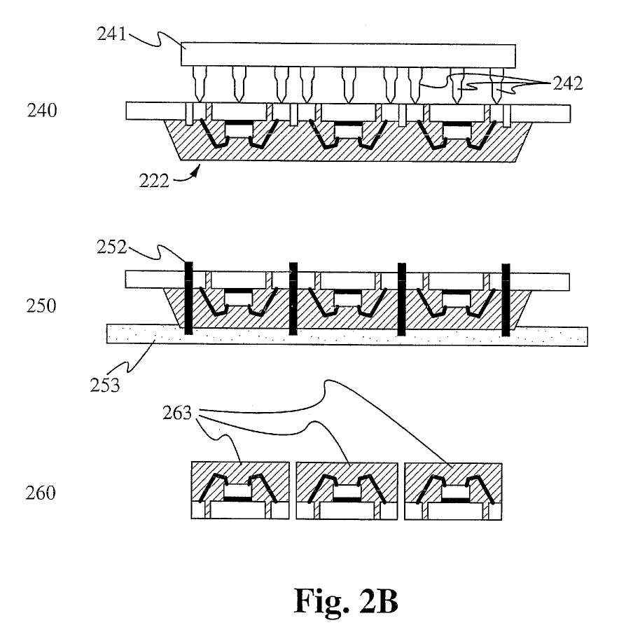

FIG. 2A shows a process 200 of assembling semiconductor devices. In a step 205, a leadframe matrix 206 is attached to a tape carrier 207. The tape carrier 207 aids in transport of the leadframe matrix 206 through the assembly process 200. In a step 210, at least one semiconductor die 211 is placed in each individual leadframe unit. To effectuate electrical contact between the die 212 and the leadframe 206, wirebonds 212 are attached from the die 211 to the individual leadframe unit. In step 215, the leadframe 206 is placed between a top mold 216 and a bottom mold 217 forming a cavity 219 in which mold compound is to be injected in a liquid state. In a step 220, mold compound 221 is allowed to set, forming an encapsulated leadframe 222 and the tape 207 is removed. Alternatively, the tape may be removed in a separate step. In a step 230, the leadframe 222 is partially saw by saws 231. This step electrically isolates each individual leadframe unit from the rest allowing for individual testing while still the leadframe 222 is still in matrix form.

FIG. 2B shows the remainder of the process of FIG. 2A. In a step 240, a contactor 241 is lowered towards the leadframe 222. The contactor 241 comprises pins 242 which contact the individual leadframe units. A tester (not shown) which is computing device having several inputs and outputs sends test signals through the pins to the semiconductor die 211. The die 211 are expected to react in a predetermined manner to the signals. For example, a power signal, commonly referred to as VDD, might cause the die 211 to send an “on” signal back through the contactor pins 242 to be received by the tester. Many test signals, such as voltage inputs, sinusoids, clocks, and the like may be utilized depending on the type of die 211 that is being tested. Most, if not all die 211 function as a “black box” where a certain input forms an expectant output. The output is received by the tester. Die 211 that are non-compliant are marked in a database with their location. Alternatively, non-compliant die are marked with an inkblot for visual identification by a line operator. The inkblot causes the non-compliant die be recognized by a line operator or an automated pick- and place device as a non-compliant die and not assembled further. In a step 250, the partially singulated leadframe 206 is attached to a saw tape 253. Longer saw blades 252 completely singulate the devices 263 in the step 260. Alternatively, the same saw blades are able to be used in the step 230 as the step 260. With current technology, it is possible to achieve tolerances sufficiently exact to partially saw the encapsulated leadframe 222 and later to completely singulate the leadframe 222. The devices 263 are able to be packaged and shipped to customers. Non compliant units are discarded.

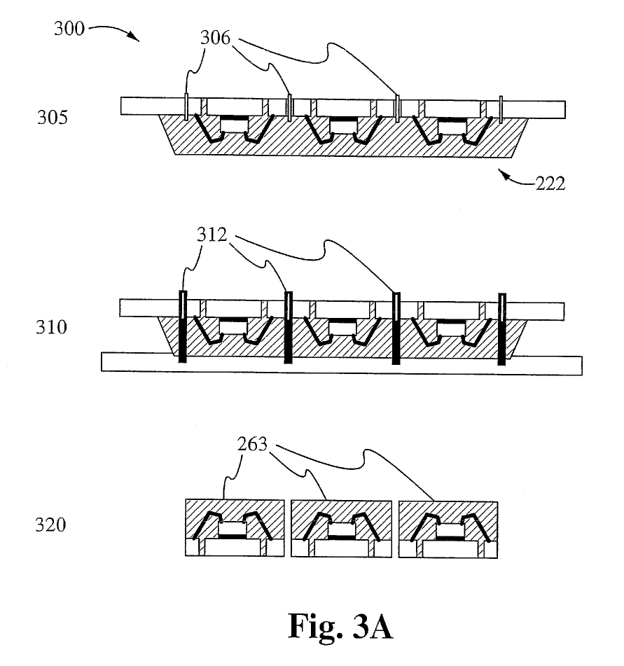

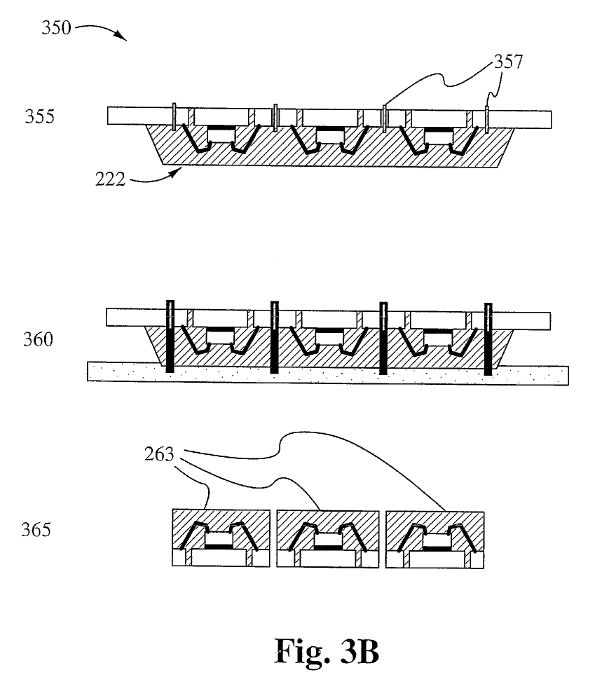

In FIG. 3A, an alternative process 300 for partially singulating is shown. For enhanced accuracy and depth of the incision, a laser 306 is able to be used for singulating the leadframe 222. In some applications, semiconductor devices 263 are made extremely thin. To that end, a physical saw is unable to achieve the necessary tolerance to partially saw the leadframe 222 without cutting through it entirely. In a step 310 the leadframe 222 is attached to saw tape 253 and the leadframe 222 is able to be singulated completely in a step 320 either by saw or again by laser.

In other applications, semiconductor devices 263 are extremely small and set very close together on a leadframe matrix 206. FIG. 3B shows a process 350 wherein thin blades 357 are utilized to partially singulate the leadframe matrix 222 in a step 355. Thin blades 357 are advantageous due to the tighter tolerances of small devices 263. In a step 360, the leadframe matrix is able to be completely singulated by standard blades, Using standard blades to completely singulate the devices 263 ensures that there is no step offset between the partial singulation and the complete singulation. If tolerances allow, an operator is still able to use a thin blade for complete singulation in the step 360. In a step 365, singulated semiconductor devices 263 are formed.

1-24. (canceled)

25. A system for assembling semiconductor devices comprising:
a. means for providing a leadframe matrix having semiconductor devices mounted thereon;
b. a cutting apparatus for partially singulating the leadframe matrix thereby forming partially singulated semiconductor devices;
c. a contactor for contacting a plurality partially singulated semiconductor devices;
d. means for transmitting at least one test signal to the plurality of partially singulated semiconductor devices;
e. means for receiving at least one response signal from the partially singulated semiconductor devices;
f. means for identifying any non compliant partially singulated semiconductor devices;
g. a cutting apparatus for completely singulating the partially singulated semiconductor devices, thereby forming completely singulated semiconductor devices; and
h. means for discarding any partially singulated semiconductor devices that did not respond according to a predetermined requirement.

26. The system of claim 19 wherein the cutting apparatus for partially singulating comprises a thin blade.

27. The system of claim 19 wherein the cutting apparatus for partially singulating comprises a standard blade.

28. The system of claim 19 wherein the cutting apparatus for partially singulating comprises a laser.

29. The system of claim 19 wherein the cutting apparatus for completely singulating comprises a thin blade.

30. The system of claim 19 wherein the cutting apparatus for completely singulating comprises a standard blade.

31. The system of claim 19 wherein the cutting apparatus for completely singulating comprises a laser.

32. The system of claim 19 wherein the means for providing a leadframe matrix having semiconductor devices mounted thereon comprises:
a. means for providing a leadframe matrix having a plurality of individual leadframe units;
b. means for mounting at least one semiconductor device in at least one of the leadframe unit, and;
c. means for encapsulating the leadframe matrix in a mold compound.

33. The process of claim 19 wherein the means for encapsulating the leadframe matrix in a mold compound comprises means for placing the leadframe matrix between a top mold and a bottom mold and injecting mold compound in a liquid state such that it encapsulates the leadframe matrix.

34. The system of claim 19 wherein the at least one test signal comprises any among a DC voltage, an AC voltage, and a frequency.

35. The system of claim 19 wherein the at least one response signal comprises any among a DC voltage, an AC voltage, and a frequency

36. The system of claim 19 wherein the means for identifying non compliant partially singulated semiconductor devices comprises a computing means for comparing the at least one response signal to a predetermined expected response.

37. The system of claim 19 wherein the means for identifying non compliant partially singulated semiconductor devices further comprises a marking means for marking a non compliant partially singulated semiconductor device in a database.

38. The system of claim 19 wherein identifying non compliant partially singulated semiconductor devices further comprises physically marking a non compliant partially singulated semiconductor device for visual identification by an operator.
